(19) United States
(12) Patent Application Publication
(10) Pub. No.: US 2005/0095194 A1
(43) Pub. Date: May 5, 2005

(54) Method for preparing zno nanopowder

(76) Inventors: Sung Park, Seoul (KR); Ju-Hyeon Lee, Choongnam (KR); Kang-Ryul Lee, Gyeonggi-do (KR)

Correspondence Address: SHERIDAN ROSS PC, 1560 BROADWAY, SUITE 1200, DENVER, CO, 80202, US

(21) Appl. No.: 10/497,985

(22) PCT Filed: Dec. 7, 2002
(86) PCT No.: PCT/KR02/02312

(30) Foreign Application Priority Data
Dec. 7, 2001 (KR) 1020010077290

(51) Int. Cl. C01G 9/02

(52) U.S. Cl. 423/622

(57) ABSTRACT

Disclosed is a method of preparing ZnO nanopowder according to a non-equilibrium synthetic process, comprising adding an organic substance containing an amine group or a carboxyl group as a fuel material to an aqueous solution having Zn²⁺ and (NO₃) ions to prepare a mixed solution, and heating the resulting solution with agitation. The method is advantageous in that the ZnO nanopowder has excellent valuable metal recovery and harmful organic substance decomposition efficiency, and the highly pure ZnO nanopowder with nano-sized particles is prepared in commercial quantities.

### TECHNICAL FIELD

The present invention relates, in general, to a method of preparing zinc oxide (ZnO) nanopowder and, more particularly, to a method of preparing highly pure microscopic semiconductor nanopowder in commercial quantities with excellent recovery efficiency of valuable metals existing in industrial waste according to a new non-equilibrium synthetic process.

### BACKGROUND ART

As well known to those skilled in the art, photocatalytic reactions are a field having a relatively short history in the field of catalytic chemistry. The function of a catalyst is mediated by interaction between a surface of the catalyst and reactant molecules, and the interaction between the catalyst and the reactant molecule generally accompanies transfer of electrons between the catalyst and the molecule.

Accordingly, a semiconductor being readily capable of controlling the concentration of electrons therein is frequently used in the study of catalytic reactions. Initial studies on photocatalysts mostly related to technologies of converting solar energy into other types of energy and storing the solar energy but, recently, studies of treating waste water, waste, or purification of air using photocatalysts have attracted considerable attention.

Various semiconductor materials are used as photocatalysts. These semiconductor materials should have high optical activity and stability, be capable of using visible light or ultraviolet light, and be low-priced so as to be practically used in a photocatalytic reaction.

Materials of photocatalysts are classified into metallic complexes represented by chlorophyll, and semiconductors. In particular, semiconductor oxides have been actively studied as photocatalysts because of their broad excited energy band gap and ease of handling. Among various semiconductor oxides, ZnO, an n-type semiconductor oxide with excess metals, which has a Wurtzite structure, acts as a crosslinking accelerator in the rubber industry, and is applied to a varistor in the electronic industry, phosphor in FED, and a photocatalyst, is growing in importance.

Meanwhile, nanopowder has peculiar physical and chemical properties in comparison with bulky materials. The nanopowder has high activity, low sintering temperature, and large specific surface area. In addition, the nanopowder may have high purity according to a method of preparing the nanopowder. Accordingly, it is expected that activity of the catalyst is improved due to increase of a catalyst surface area and variation of its surface properties such as surface defects when the nanopowder is applied to the catalyst.

Furthermore, materials used as the desirable photocatalyst should be stable in a solution when a beam having higher energy than the band gap of the material is irradiated to the material, and readily dispersed so as to improve particle efficiency, that is to say a ratio of measured surface area to theoretical total surface area of particles constituting the material. Accordingly, it is important to prepare a stable and well-dispersed nanopowder so as to improve optical activity of the photocatalyst.

Conventional methods of preparing zinc oxide are classified into a vapor method and a sol-gel method. However, the vapor method is disadvantageous in that it is actually impossible to prepare nano-sized ZnO because zinc oxide is formed in the shape of agglomerates due to difficulty in controlling reaction conditions. On the other hand, the sol-gel method has disadvantages in that stringent control of reaction conditions is needed even though uniform zinc oxide powder may be formed because of a violent hydrolysis reaction under atmosphere, and it is very costly to prepare zinc oxide in commercial quantities because of expensive alkoxide used as a reactant. Therefore, this method is attempted on laboratory level.

### DISCLOSURE OF THE INVENTION

Accordingly, the present invention has been made keeping in mind the above problems occurring in the prior art, and an object of the present invention is to provide a novel method of preparing zinc oxide powder as photocatalytic semiconductor powder with nano-sized particles in commercial quantities.

In order to accomplish the above object, the present invention provides a method of preparing ZnO nanopowder, comprising adding an organic substance containing an amine group or a carboxyl group as a fuel material to a starting material solution having Zn²⁺, (NO₃)⁻, and (OH)⁻ ions to prepare a mixed solution, and heating the mixed solution with agitation.

Moreover, the present invention further provides a method of preparing ZnO nanopowder characterized in that the organic substance containing the amine group or the carboxyl group is selected from the group consisting of carbohydrazide, oxalic dihydrazide, 1-methyl-3-nitroguanidine, ammonium perchlorate, urea hydrogen peroxide, and guanidine nitrate in the above method.

Further, the present invention further provides a method of preparing ZnO nanopowder characterized in that the mixed solution is prepared by dissolving Zn(NO₃)₂·6H₂O and the fuel material in distilled water in a beaker in the above method.

Furthermore, the present invention further provides a method of preparing ZnO nanopowder characterized in that the mixed solution is prepared by dissolving Zn(OH)₂ and nitric acid in distilled water and then adding the fuel material in the above method.

In addition, the present invention further provides a method of preparing ZnO nanopowder characterized in that the starting material solution is mixed with the fuel material in a non-equilibrium state such that an oxidation number ratio of the starting material solution to the fuel material is not 1 in the above method.

The present invention also provides a product for removing harmful gas, treating industrial waste, or purifying air, including ZnO nanopowder prepared by such method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a X-ray diffraction pattern of zinc oxide powder according to the present invention;

FIG. 2 is a transmission electron microscope picture illustrating shape and size of particles constituting zinc oxide powder according to the present invention;

FIG. 3 is a graph comparing efficiencies of photocatalysts with each other when recovering Ag from each powder sample;

FIG. 4 is a graph comparing efficiencies of photocatalysts with each other when recovering Cu from each powder sample; and

FIG. 5 is a graph showing the result of a decomposition test of organic substance in waste water using various photocatalysts.

### BEST MODE FOR CARRYING OUT THE INVENTION

A detailed description of the present invention will be given, below.

According to the present invention, a method of preparing zinc oxide (ZnO) nanopowder is performed in accordance with following procedure. An initial solution containing metal ions (oxidant) is prepared, and a fuel material is then added to this solution. The initial solution contains ions such as Zn²⁺, (NO₃)⁻, and (OH)⁻ and for example, may be prepared by dissolving Zn(NO₃)₂·6H₂O or Zn(OH)₂ powder in nitric acid. Then the fuel material is added, whereby the fuel material is selected from the group consisting of glycine (H₂NCH₂COOH), carbohydrazide (H₂NNHCONHNH₂), oxalic dihydrazide, 1-methyl-3-nitroguanidine, ammonium perchlorate, urea hydrogen peroxide, and guanidine nitrate.

Meanwhile, the present invention is based on a non-equilibrium synthetic process modified from a general glycine-nitrate process (GNP). The GNP is conducted under an equilibrium state due to spontaneous combustion of the fuel, that is to say an oxidation number ratio of the oxidant to the fuel =1, adjusted by controlling each oxidation number of an oxidant (starting material) and the fuel. For example, when glycine is used as the fuel, the oxidation number of the oxidant is calculated and controlled to prepare ZnO powder containing unreacted commuted impurities according to the GNP. On the other hand, in the present invention, after each oxidation number of the oxidant and fuel is calculated, an aqueous solution is prepared in a non-equilibrium state, that is to say, excess oxidant or fuel is added to the solution to spontaneously combust the fuel, unlike the glycine-nitrate process. At this time, the oxidation number ratio of the oxidant to the fuel is not 1. This process according to the present invention is defined as a non-equilibrium synthetic process.

An amount of each agent added to the solution is quantitatively calculated according to the chemical reaction equations below, and agents are added to the solution in the amount within a desirable range (in the non-equilibrium state) based on a calculated amount of the agent. Chemical reactions occurring in the present invention may be represented as follows:
Zn(OH)₂+2HNO₃→Zn(NO₃)₂+2H₂O (aqueous solution state, starting material: Zn(OH)₂)
Zn(NO₃)₂+2H₂O+fuel→ZnO+xN₂↑+yCO₂↑

The resulting solution is heated by a hot plate to a temperature capable of boiling water (for example about 80 to 200° C.), with agitation using a magnetic bar.

After distilled water is vaporized, the solution is converted into viscous liquid phase to form small bubbles and emit gas. The resulting liquid is then put in a collection device to react nitrate groups with the fuel to instantaneously generate very high heat (about 1500 to 1700° C.) and high pressure to cause explosive combustion, thereby preparing metal oxide, that is to say, zinc oxide (ZnO) powder.

A better understanding of the present invention may be obtained through the following example which is set forth to illustrate, but is not to be construed as the limit of the present invention.

### EXAMPLE

1. Preparation of Mixed Solution Samples

1) 0.05 mole Zn(NO₃)₂·6H₂O and 0.044 mole glycine were put into a beaker and dissolved using 300 ml of distilled water in the beaker to prepare a mixed solution sample 1.

2) 0.05 mole Zn(NO₃)₂·6H₂O and 0.0666 mole carbohydrazide were put into a beaker and dissolved using 300 ml of distilled water in the beaker to prepare a mixed solution sample 2.

3) 0.05 mole Zn(OH)₂ powder was dissolved in 300 ml of distilled water containing 8.25 g of 13.4 M nitric acid solution, and 0.44 mole glycine was then added and dissolved in the resulting solution to prepare a mixed solution sample 3.

4) 0.05 mole Zn(OH)₂ powder was dissolved in 300 ml of water containing 8.25 g of 13.4 M nitric acid solution, and 0.0666 mole carbohydrazide was then added and dissolved in the resulting solution to prepare a mixed solution sample 4.

2. Preparation and Analysis of Zinc Oxide Nanopowder Having High Purity

Four mixed solution samples thus prepared were heated by a hot plate with agitation using a magnetic bar, respectively. After distilled water was vaporized, the solutions were converted into viscous liquids to form small bubbles and emit gas.

Each resulting liquid was then put in a collection device to be explosively combusted with generation of high heat, thereby producing the metal oxide white zinc oxide (ZnO) powder in the shape of sphere or rod. At this time, size and shape of the particles constituting the powder depended on the starting material and fuel.

In the case of powder including sphere-shaped particles, Zn(OH)₂ was used as the starting material and glycine was used as the fuel, and in the case of powder having rod and plate-shaped particles, Zn(NO)₃ was used as the starting material and carbohydrazide was used as the fuel.

The ZnO nanopowder was subjected to a heat treatment at 400° C. so as to remove a small amount of NO₃ gas remaining on the surface of the ZnO nanopowder, thereby obtaining finally the target ZnO powder.

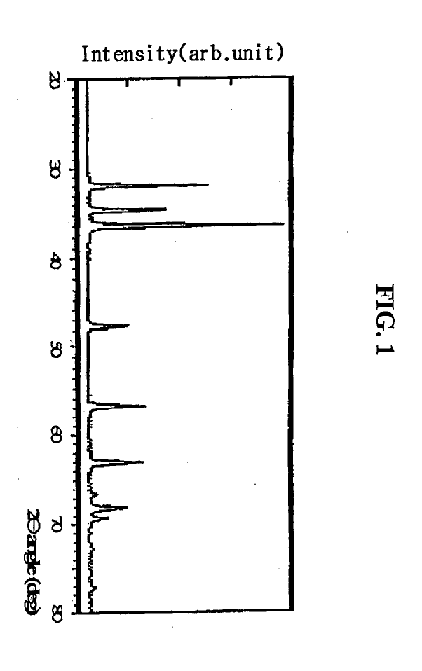

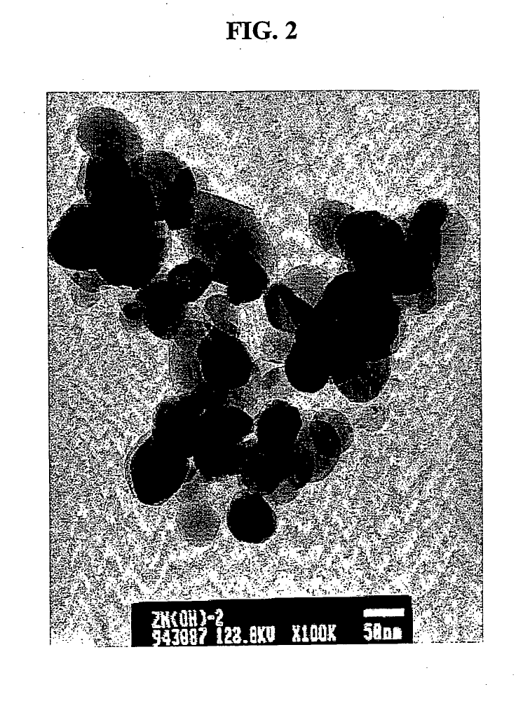

ZnO nanopowder prepared from the mixed solution sample 3 was qualitatively analyzed according to an X-ray diffraction method to confirm crystallinity of the powder, and an X-ray diffraction pattern of the powder is shown in FIG. 1. FIG. 2 is a transmission electron microscope picture illustrating shape and size of particles constituting zinc oxide powder according to the present invention, in which size of each particle was extremely minute in the range of tens of nanometers.

3. Photocatalyst Effect

(1) Silver (Ag) Recovery Test

CeO₂ synthesized under the same conditions as the present invention, TiO₂ synthesized according to a conventional HPPLT (homogeneous precititation process at low temperature) process, TiO₂ manufactured by Degussa Co. of Germany, and ZnO powder prepared from the mixed solution sample 3 of the present invention each were dipped in waste water containing silver and irradiated by ultraviolet light to test the recovery performance of silver by photocatalytic effect.

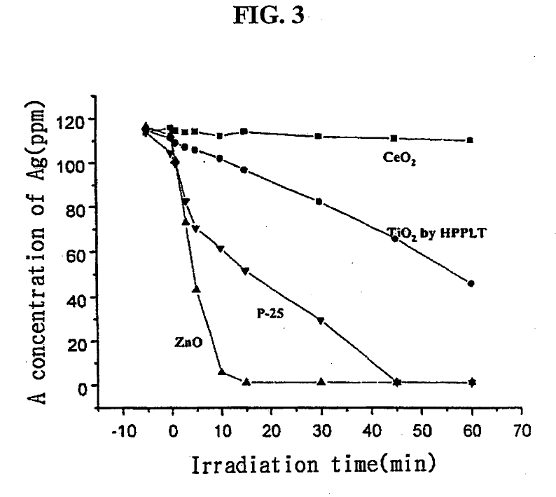

As shown in FIG. 3, it took 45 minutes to completely recover silver from the waste water (i.e. until a silver concentration in the waste water is 0) in the case of using TiO₂ manufactured by Degussa Co., known as the metal oxide with the best performance among conventional metal oxides. On the other hand, by using ZnO powder of the present invention, it took only 15 minute to completely recover silver from the waste water. Accordingly, the powder of the present invention has three times better performance than the conventional best powder.

(2) Copper (Cu) Recovery Test

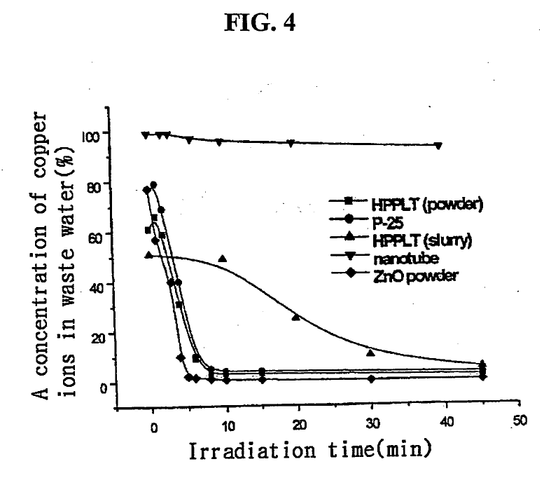

Powder used in the above test was tested in the view of recovery performance of copper ions, and the results as shown in FIG. 4. In FIG. 4, HPPLT (slurry) was a slurry type of TiO₂ synthesized according to a conventional HPPLT process, and nanotube was a nanotube type of TiO₂. From the test results, it could be seen that a Cu ion concentration was not reduced to 3% or less even though ultraviolet light was irradiated to waste water for a long time in the case of TiO₂ powder manufactured by Degussa Co., but the Cu ion concentration was 0 after an irradiation time of about 5 minutes, thereby completely recovering Cu ions in the case of using ZnO powder of the present invention.

(3) Organic Substance Decomposition Test

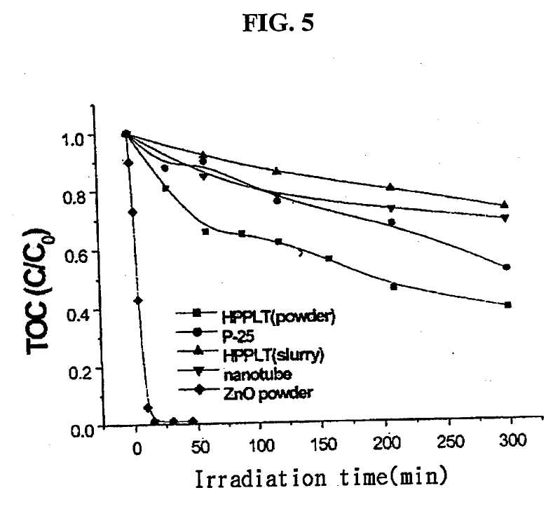

The same samples as those used in the above test were tested for decomposition performance of organic substances in waste water. FIG. 5 is a graph illustrating a total organic carbon (TOC) concentration in the waste water as a function of irradiation time of ultraviolet rays. These results showed that a concentration of organic substance was 50% or higher after the irradiation time of 300 minutes in the case of using TiO₂ powder manufactured by Degussa Co., but ZnO powder of the present invention recovered most organic substances in about 15 is minutes, thereby proving excellent organic substance decomposition ability of ZnO powder according to the present invention.

### Industrial Applicability

As described above, a method of preparing ZnO powder according to the present invention is advantageous in that highly pure ZnO nanopowder having superior valuable metal recovery and organic substance decomposition efficiency, compared to a conventional photocatalytic powder, is prepared in commercial quantities.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of preparing ZnO nanopowder, comprising:
adding an organic substance containing an amine group or a carboxyl group as a fuel material to a starting material solution having Zn²⁺, (NO₃)⁻ and (OH)⁻ ions to prepare a mixed solution; and
heating the mixed solution with agitation.

2. The method according to claim 1, wherein the organic substance containing the amine group or the carboxyl group is selected from the group consisting of glycine, carbohydrazide, oxalic dihydrazide, 1-methyl-3-nitroguanidine, ammonium perchlorate, urea hydrogen peroxide, and guanidine nitrate.

3. The method according to claim 1, wherein the mixed solution is prepared by dissolving Zn(NO₃)₂·6H₂O and the fuel material in distilled water in a beaker.

4. The method according to claim 1, wherein the mixed solution is prepared by dissolving Zn(OH)₂ and nitric acid in distilled water and then adding the fuel material.

5. The method according to claim 1, wherein the starting material solution is mixed with the fuel material in a non-equilibrium state such that an oxidation number ratio of the starting material solution to the fuel material is not 1.

6. A product for removing harmful gas, treating industrial waste, or purifying air, comprising ZnO nanopowder prepared by the method according to claim 1.

7. A product for removing harmful gas, treating industrial waste, or purifying air, comprising ZnO nanopowder prepared by the method according to claim 2.

8. A product for removing harmful gas, treating industrial waste, or purifying air, comprising ZnO nanopowder prepared by the method according to claim 3.

9. A product for removing harmful gas, treating industrial waste, or purifying air, comprising ZnO nanopowder prepared by the method according to claim 4.

10. A product for removing harmful gas, treating industrial waste, or purifying air, comprising ZnO nanopowder prepared by the method according to claim 5.
